(19) United States
(12) Patent Application Publication
(10) Pub. No.: US 2002/0102938 A1
(43) Pub. Date: Aug. 1, 2002

(54) Portable device, mobile phone, image transmission system, and method of transmitting image

(76) Inventors: Hisayoshi Tsubaki, Asaka-shi (JP); Mikio Watanabe, Asaka-shi (JP); Hiroshi Tanaka, Asaka-shi (JP)

Correspondence Address: McGinn & Gibb, PLLC, Suite 200, 8321 Old Courthouse Road, Vienna, VA, 22182-3817, US

(21) Appl. No.: 10/057,919

(22) Filed: Jan. 29, 2002

(30) Foreign Application Priority Data
Jan. 30, 2001 (JP) 2001-022119

(51) Int. Cl. H04H 1/00; H04H 7/00; H04M 1/00; H04B 1/38

(52) U.S. Cl. 455/3.06; 455/556; 455/3.05

(57) ABSTRACT

A service information input device (transmit/receive device and recording medium interface) is provided for inputting service information about image service from a communication device such as a mobile phone, and a recording device (recording medium interface and information processing device) is provided for recording an image based on the inputted service information in a recording medium. Thus, when an image is transferred to a mobile phone via the recording medium, which can be loaded and unloaded, it is possible to record an image, which is automatically changed in size or compressibility of an image based on obtained service information, in the recording medium. Thereby, a portable device, a mobile phone, an image transmission system, and a method of transmitting an image can readily transmit an image to a server for providing image service such as printing and distribution of an image at high speed.

### BACKGROUND OF THE INVENTION

1. Field of the Invention

The present invention relates to a portable device, a mobile phone, an image transmission system, and a method of transmitting an image, and particularly concerns a portable device, a mobile phone, an image transmission system, and a method of transmitting an image that transmit an image to a server for providing image service such as printing and distribution of an image.

2. Description of the Related Art

Conventionally, a mobile phone and a server for providing a variety of services have communicated with each other to provide a variety of services. Particularly in recent years, a mobile phone with a camera and a mobile phone capable of placing a detachable recording medium therein, which can be loaded and unloaded, have been introduced to the market. Thus, it has been possible to handle an image such as a photo with a mobile phone.

Further, in contrast to a camera using a conventional silver-halide film, an electronic camera has been widely available, which can electrically process a captured image and record the image in a recording medium as information. Technological innovation on such an electronic camera has progressed rapidly, and the number of recording pixels and recorded color information have increased largely. Moreover, as for a device which outputs image information to other devices from an electronic camera, a device using a conventional recording medium, wire serial communication, and wireless communication have been performed. Therefore, even on a trip, it has been possible to transmit information such as an image from an electronic camera to an image service center, home, and so on via a mobile phone.

Japanese Patent Application Publication No. 9-65111 discloses a still image transmitter, which includes a control information receiving section for receiving control information from a receiving terminal. The control information instructs resolution and an image region requiring transfer with high image quality. A captured region is controlled in an image region control section according to control information received in the control information receiving section, a resolution depending upon a transferred image and the like is controlled by a resolution control section, only an image region instructed by a receiver is inputted with high resolution from an image input section, the image region is transmitted, and communication time and cost resulting from unnecessary transmission of a high-quality image can be reduced.

However, the still image transmitter of Japanese Patent Application Publication No. 9-65111 is disadvantageous as follows: although a high-resolution transmission region can be set by an instruction of a receiver, an image cannot be transmitted via a mobile phone.

Further, Japanese Patent Application Publication No. 11-203464 discloses a data storing apparatus including a first storage device which stores digital image data and digital image data converted from analog image video signals, a second storage device which stores a data format for each model when data is downloaded for an electronic device having the function of processing an image, and a control device which allows the second storage device to store a data format when data is inputted from an electronic device connected to an input/output terminal, exercises control such that the first storage device stores the input image data based on the data format stored in the second storage device, and exercises control such that the image data is read and transmitted to the input terminal when access is made to request image data of the first storage device via the input terminal. The data storing apparatus is highly convenient with no limit on models of an electronic device.

However, the data processing device of Japanese Patent Application Publication No. 11-203464 is disadvantageous as follows: a variety of image formats requested for use by a receiver cannot be handled because only a necessary region is transmitted with high resolution but other regions are transmitted with low resolution when image data is transmitted.

Another disadvantage has been found as follows: when image data is uploaded to various service servers from a portable electronic camera via a mobile phone, since an image has quite a large amount of information relative to a speed of transferring information of a mobile phone, it takes several tens minutes to several hours depending upon an amount of image information to transmit information such as an image from an electronic camera to a mobile phone.

Also, another problem is that during transmission of the image information, conditions may be required on the content of usage. For example, other processing functions of an electronic camera and a mobile phone may be limited. Besides, since a battery is exhausted soon due to communication, an electronic camera and a mobile phone cannot be used in some cases because a battery is exhausted before completion of image transmission.

Moreover, another problem is that when a communication speed between an electronic camera and a mobile phone is largely different from a transferring speed of information between a mobile phone and a service server, management of communication is complicated. For example, management is complicated for a buffer memory which temporarily stores information.

Additionally, when image information is transmitted to a service server via a mobile phone to obtain printing service for an image stored in an electronic camera, determination cannot be made in many cases if a form of an image captured by an electronic camera is suitable for printing service or not (including resolution of an image, a file format of an image, and a compressing format of an image). Thus, service may not be obtained for the captured image. Further, even when a user knows an image form suitable for printing service, it is necessary to operate an electronic camera to convert the image form to a predetermined image form. Hence, the operation is inconvenient and the user may have a setting error.

### SUMMARY OF THE INVENTION

The present invention has been developed in view of the above-described circumstances, and has as its object the provision of a portable device, a mobile phone, an image transmission system, and a method of transmitting an image whereby when an image is transferred to a mobile phone from a portable device such as an electronic camera via a recording medium, which can be loaded and unloaded, a size or a compressibility of the image is changed and is automatically recorded in a recording medium at high speed, according to service information obtained from a server which finally receives the image.

Further, another object of the present invention is to provide an image transmission system and a method of transmitting an image that can transmit to a server necessary and sufficient image data based on the content of service of an image desired by a user.

In order to attain the above objects, the present invention is directed to a portable device which records, in a recording medium, an image to be transmitted to a server via a communication device such as a mobile phone, the server providing image service such as printing and distribution service of an image, the portable device comprising: a service information input device which inputs, from the communication device, service information about image service such as: a format of the image such as an image recording format or an image format; an aspect ratio of the image or a permissible range of the aspect ratio; numbers of pixels in vertical and horizontal directions of the image or a permissible range of the numbers of pixels; and compressibility for compressing and recording the image, a file size of the image upon recording, or a permissible range of the compressibility or the file size; and a recording device which records the image based on the inputted service information in the recording medium.

According to the present invention, the service information input device is provided for inputting service information about image service from a communication device such as a mobile phone, and the recording device is provided for recording an image based on the inputted service information in the recording medium. Thus, when an image is transferred to a mobile phone via a recording medium, which can be loaded and unloaded, it is possible to record an image, which is automatically changed in size or compressibility according to obtained service information, in the recording medium.

Further, in order to attain the above objects, the present invention is directed to a mobile phone which is capable of performing voice communication, communicating information to a server for providing image service such as printing service and distribution service of an image, and transmitting an image recorded in a recording medium to the server, the recording medium being loaded and unloaded, the mobile phone comprising: a receiving device which receives, from a server, service information about image service such as: a format of the image such as an image recording format or an image format; an aspect ratio of the image or a permissible range of the aspect ratio; numbers of pixels in vertical and horizontal directions of the image or a permissible range of the numbers of pixels; and compressibility for compressing and recording the image, a file size of the image upon recording, or a permissible range of the compressibility or the file size; a service information output device which outputs the received service information to a portable device; and a transmitting device which transmits to the server the image read from the recording medium.

According to the present invention, the receiving device is provided for receiving service information about image service from the server, the service information output device is provided for outputting the received service information to the portable device, and the transmitting device is provided for transmitting to the server an image read from the recording medium, which can be loaded and unloaded. Thus, it is possible to readily transmit to the server an image meeting the request of the server.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a view showing an image transmission system of the present invention;

FIG. 2 is a block diagram showing a signal processing system of a portable device according to the present invention;

FIG. 3 is a block diagram showing a signal processing system of a mobile phone according to the present invention;

FIG. 4 is a flowchart showing the steps in which an electronic camera records in a recording medium an image captured according to service information recorded in the recording medium;

FIG. 5 is a view showing a service selection screen which is displayed on a display device of the mobile phone;

FIG. 6 is a view showing the content of service information downloaded from a server; and

FIG. 7 is a flowchart showing the steps in which the electronic camera records in the recording medium an image captured according to service information received via a communication device.

### DETAILED DESCRIPTION OF THE PREFERRED EMBODIMENTS

Hereunder preferred embodiments will be described in detail for a portable device, a mobile phone, an image transmission system, and a method of transmitting an image of the present invention in accordance with the accompanied drawings.

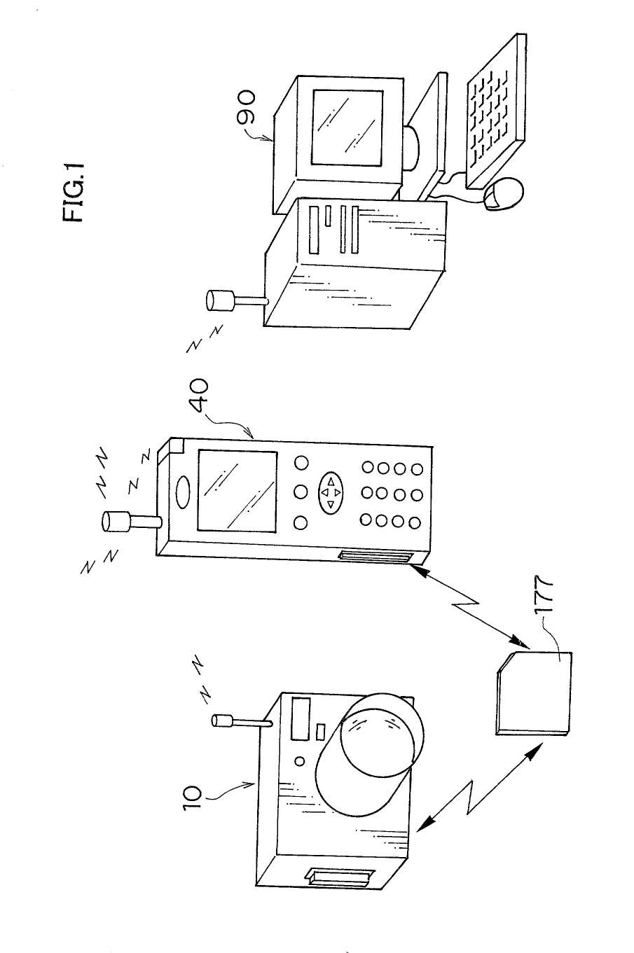

FIG. 1 is a view showing the image transmission system of the present invention.

FIG. 1 shows an electronic camera 10 as a form of a portable device, and a mobile phone 40 for transmitting information such as an image to a server 90 by radio waves. The information is obtained from the electronic camera 10 via a recording medium 177, which can be loaded and unloaded. The electronic camera 10 can record an image in a predetermined image form (including a recording format of an image, a recording format of an image, an aspect ratio of an image, the numbers of pixels in vertical and horizontal directions of an image, compressibility for compressing and recording an image, and an image size after compression) in the recording medium 177. The mobile phone 40 can transmit an image recorded in the recording medium 177 to a server. Besides, communication between the mobile phone 40 and the server 90 may be wireless communication via a public line.

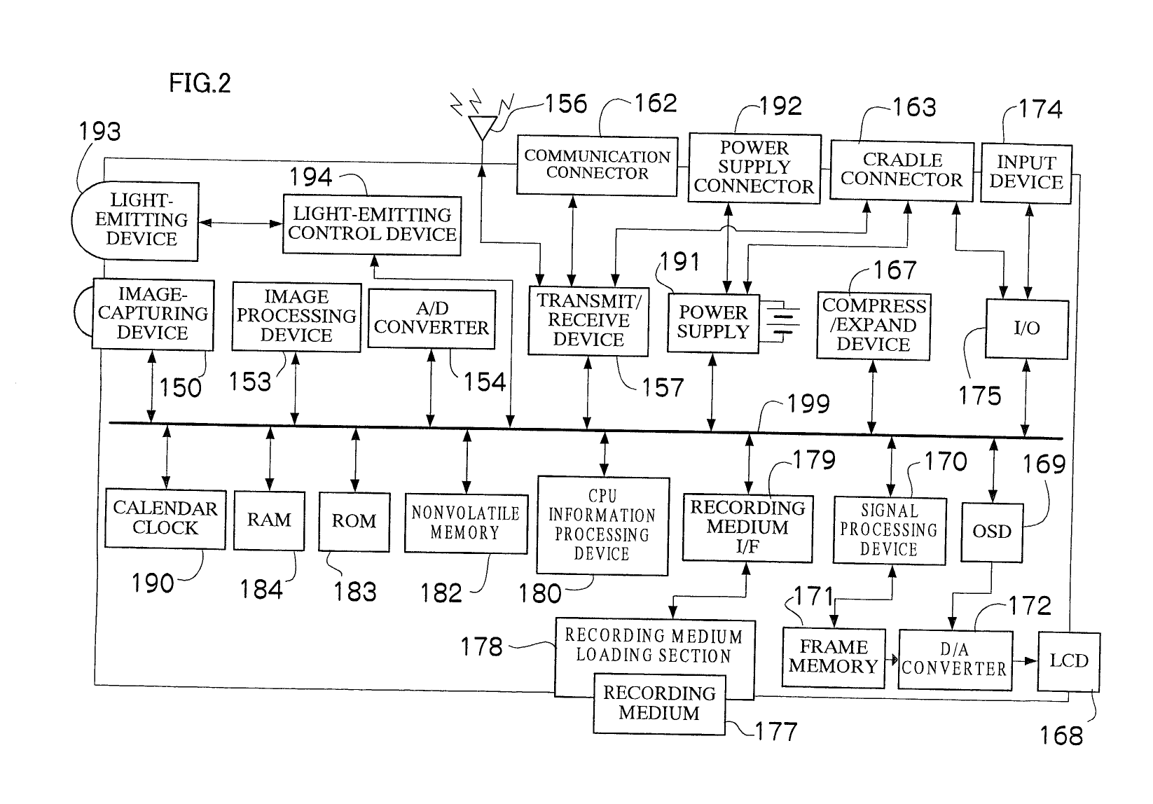

FIG. 2 is a block diagram showing a signal processing system of the portable device according to the present invention.

An image processing section of the electronic camera 10, which is a form of a portable device having an image-capturing device, includes an image-capturing device 150 which forms an image of a subject on a light-receiving surface, performs photoelectric conversion thereon, and outputs the image as an image signal, an image processing device 153 which performs processing such as changing image size, correction of sharpness, edge processing, and correction of contrast, and an A/D converter 154 which converts an analog image signal to digital image data.

Moreover, a communication device of the electronic camera 10 transmits and receives image data, identifying information specific to a portable device, and information such as service information with other communication devices by communication, and the communication device includes a transmit/receive device 157 (including the function of a service information inputting device) for a short distance that transmits or receives information such as image data and service information by carrier waves such as radio waves, an antenna 156 for transmitting and receiving carrier waves and image data, a communication connector 162 for transmitting and receiving information such as image data and service information with other communication devices via a communication cable, and a cradle connector 163 for transmitting and receiving information with other communication devices via a cradle for mounting the electronic camera 10.

Besides, the electronic camera 10 includes a compress/expand device 167 which compresses or thins out information such as image data by a method typified by JPEG and motion JPEG and which expands compressed image data, an OSD 169 which displays a variety of characters displayed on a display device 168 and message data together with an image on a screen, a signal processing device 170 which performs a white balance operation on image data obtained by image-capturing, gamma conversion, YC conversion, conversion of the number of pixels, electronic zooming, trimming, and so on, a frame memory 171 for temporarily storing image data for display, and a D/A converter 172 for converting digital image data to composite signals for display.

Further, the electronic camera 10 is composed of an input device 174 including a power switch, a release button, a communication button, a transmission button, a function switch, a cross button, a determining switch, and a switch for switching a mode, an I/O 175 acting as an interface for inputting and outputting information inputted from the input device 174 and information for a display device such as an LED, a recording medium loading section 178 for detachably loading the recording medium 177, and a recording medium interface 179 (including the function of an image reading device, the function of a service information inputting device, and the function of a recording device) which records and reads information such as image data for the recording medium 177. Additionally, the recording medium 177 is a semiconductor such as a memory card and is a detachable recording medium such as an MO of a magnetic recording type, an optical recording type, and so on.

Moreover, the electronic camera 10 includes an information processing device 180 (may include the function of a recording device) which entirely controls the electronic camera 10, controls sampling timing of image data, controls recording of image data, recognizes graphics of image data, reads device information of the electronic camera 10 or identifying information specific to the device, controls communication, controls recording of an image and voice, and controls display, a nonvolatile memory 182 (recording device) which can rewrite information and continues to store information such as various constants for adjustment even after power is turned off, a ROM 183 for storing identifying information specific to a portable device that includes the model and serial number of the electronic camera 10, default operating programs, various constants, and so on, and RAM 184 which is a storage device being capable of reading and writing at high speed and acts as a workspace when programs are executed.

Besides, the electronic camera 10 is composed of a calendar clock 190 for ticking time, a power supply 191 for supplying a various kinds of power for driving the electronic camera 10, a power supply connector 192 for receiving power from an external power supply, a light-emitting device 193 which makes up for a shortage of light by emitting light to a subject during image-capturing, and a light-emitting control device 194 which adjusts emitting timing and an amount of emitted light of the light-emitting device 193.

The information processing device 180 of the electronic camera 10 and peripheral circuits around the information processing device 180 are connected with each other via a bus 199 so as to convey information to each other at high speed.

Additionally, the information processing device 180 of the electronic camera 10 converts a captured image or an image recorded in an image recording device such as the recording medium 177 according to a recording format of an image read from the recording medium 177, an aspect ratio of an image, the numbers of pixels in vertical and horizontal directions of an image, or compressibility when an image is compressed and recorded, service information on image service such as a file size of an image upon recording, or the service information inputted via the transmit/receive device 157. And the information processing device 180 can instruct the peripheral circuits to record the converted image in the recording medium 177. The peripheral circuits perform instructed operations according to the instruction of the information processing device 180. Additionally, an image is read from the image recording device by an image reading device such as the recording medium interface 179 or the information processing device 180.

Further, in addition to an image, the information processing device 180 can instruct to record the service information, server identifying information which specifies a server for providing image service inputted with service information, and service content information indicating the content of image service, in the recording medium 177.

The following will discuss image-capturing processing of the electronic camera 10 configured thus.

A captured image is formed on a light-receiving surface of the image-capturing device 150 by a lens 102. The formed subject image undergoes photoelectric conversion and is outputted to the image processing device 153. The image processing device 153 performs image processing including correlation double sampling, amplification, and a noise-reducing operation on an image signal, and the A/D converter 154 converts the signal to digital data.

The image data converted to digital data is transferred to the signal processing device 170 in response to an instruction of the information processing device 180. After the image data undergoes image processing such as correction of white balance, gamma correction, YC conversion, a zooming operation, and changing of the number of pixels, the image data is temporarily stored in the frame memory 171 such as VRAM. The frame memory 171 has a storage capacity according to the number of pixels and gradation of color displayed by the display device 168.

The information processing device 180 instructs image data, which is stored in the frame memory 171, to be sequentially conveyed to the D/A converter 172, and the image data is displayed on the display device 168 together with information such as characters from the OSD 169.

When a user pushes the release button, which is provided in the input device 174 to instruct the capturing of an image, the information processing device 180 enters a mode for capturing an image of a subject. Subsequently, the information processing device 180 stores in the RAM 184 image data converted to digital data in the A/D converter 154. The image data has 12-bit gradation for each of primary colors RGB.

When an image is recorded in the recording medium 177, an image stored in the RAM 184 is sequentially read and is transferred to the signal processing device 170. After gradation is converted for each color and the size of an image is changed by performing image processing such as correction of white balance, gamma correction, YC conversion, a zooming operation, and changing the number of pixels, the image is transferred to the compress/expand device 167.

The image data compressed by the compress/expand device 167 under predetermined conditions is temporarily stored in a FILE workspace of the RAM 184 again in response to the instruction of the information processing device 180. Thereafter, after conversion to image data for recording, the image data is outputted to the recording medium interface 179 and is sequentially recorded in the recording medium 177.

As shown in FIG. 1, the electronic camera 10 can transmit identifying information specific to the device that includes a serial number and ID of the electronic camera 10, and image data to a personal computer 80 via the cradle 12 and the communication cable 14.

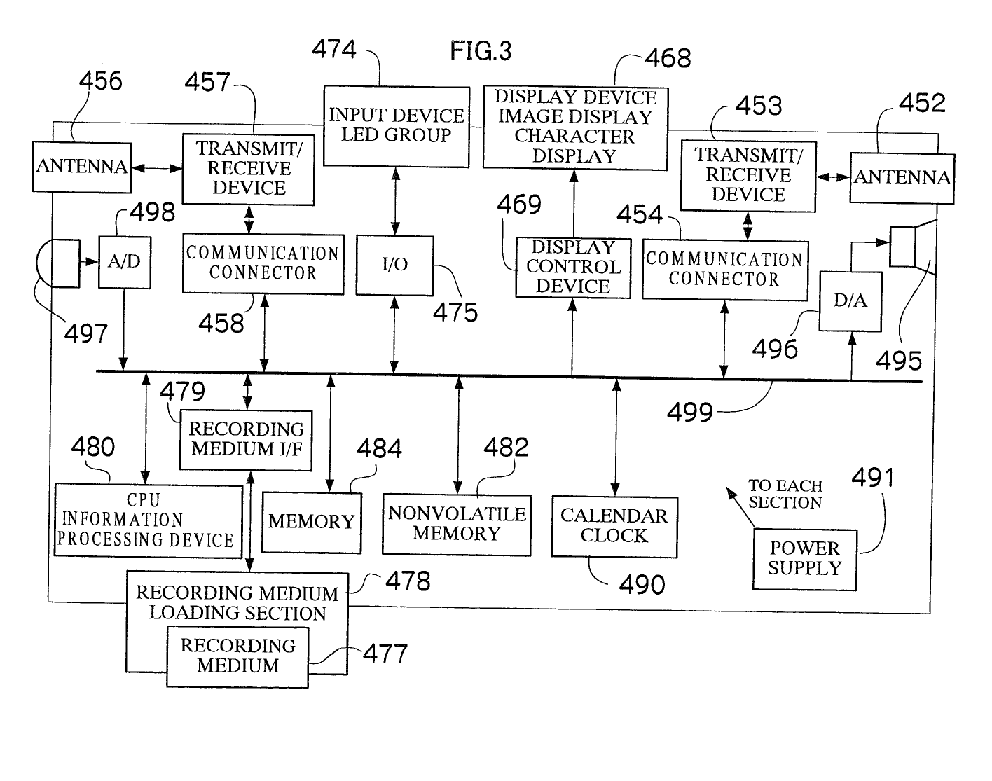

FIG. 3 is a block diagram showing the signal processing system of the mobile phone.

In FIG. 3, the information transmit/receive section of the mobile phone 40 includes an antenna 452 for performing wireless communication with a public line, a transmit/receive device 453 (including the functions of a transmitting device and a receiving device) for a public line, a transmit/receive buffer 454 for temporarily storing information which is transmitted and received in real time, an antenna 456 used as a short-distance wireless communication device, a transmit/receive device 457 (including the functions of a transmitting device, a receiving device, and a service information output device), and a transmit/receive buffer 458.

Moreover, the mobile phone 40 includes a display device 468 for displaying information such as an image and characters, a display control device 469 for outputting an image signal for display to the display device 468 in response to an instruction of the information processing device, and an I/O 475 which reads various kinds of information inputted by a user using the input device 474, transmits the information to the information processing device discussed below, and outputs an instruction of providing display to a notification device such as an LED in response to an instruction from the information processing device.

In addition, the mobile phone 40 includes a recording medium loading section 478 for detachably loading a recording medium 477 (the same type as the recording medium 177 loaded into the electronic camera 10), and a recording medium interface 479 (service information output device) for recording and reading information such as image data for the recording medium 477, service information, service content information, and server identifying information.

Moreover, the mobile phone 40 includes an information processing device (CPU) 480 for entirely controlling the mobile phone 40, a rewritable nonvolatile memory 482 which records connection information such as various constants of processing of the mobile phone, a dial-up number for communicating with a communication device on a network, attribute information, URL (Uniform Resource Locators), IP (Internet Protocol) address, and gateway information DNS (Domain Name System), a memory 484 composed of a ROM, which records programs for operating the information processing device 480 and various constants, and RAM serving as a storage device, which is used as a workspace when the information processing device 480 performs processing, a calendar clock 490 for ticking time, and a power supply 491 for supplying power to circuits including the information processing device 480.

Additionally, regarding various kinds of service information received by the transmit/receive device 453 from a server, server identifying information for identifying a server, and service content information including the content of service for an image, recording is performed in the recording medium 477 after the information processing device 480 instructs the recording medium interface 479 to record information. Further, when the various contents of service are transmitted to a portable device by using a wireless or a cable communication device, the processing is performed after the information processing device 480 instructs the transmit/receive device 457 to transmit the contents of service.

In addition, the mobile phone 40 includes a speaker 495 which acts as a receiver when a user uses the telephone and which outputs voice, a D/A converter 496 which converts voice data outputted from the information processing device 480 to an analog aural signal, amplifies the signal, and outputs the signal to the speaker 495, a microphone 497 which inputs voice and converts it to an aural signal, and an A/D converter 498 which amplifies an aural signal inputted from the microphone 497 and converts the signal to voice data to be transmitted to the information processing device 480.

The information processing device 480 in the mobile phone 40 is connected via a bus 499 to peripheral circuits including the transmit/receive buffer 454, the transmit/receive buffer 458, the display control device 469, the I/O 475, the recording medium interface 479, the nonvolatile memory 482, the memory 484, the calendar clock 490, the D/A converter 496, and the A/D converter 498. The information processing device 480 can control the peripheral circuits and can transmit and receive information at high speed.

The wireless communication device for a short distance is a communication device which uses carrier waves of radio waves, ultrasonic waves, and light such as infrared radiation. When radio waves are used, communication may be performed according to the specification of wireless communication such as wireless LAN (local area network).

In addition to the communicating function as an ordinary telephone, the mobile phone 40 can display information from the server 90, record the information in the recording medium 477, transmit information inputted by a user to the server 90, and transmit an image recorded in the recording medium 477 to the server 90.

Additionally, the server 90 includes the communication device and data base (storage device) that can transmit and receive information via a public line and a communication network. Therefore, information can be received from the mobile phone 40, and it is possible to provide service including service of printing a received image and delivering it to a user, service of offering a calendar, service of offering a poster, and service of releasing an image on-line or on the Internet.

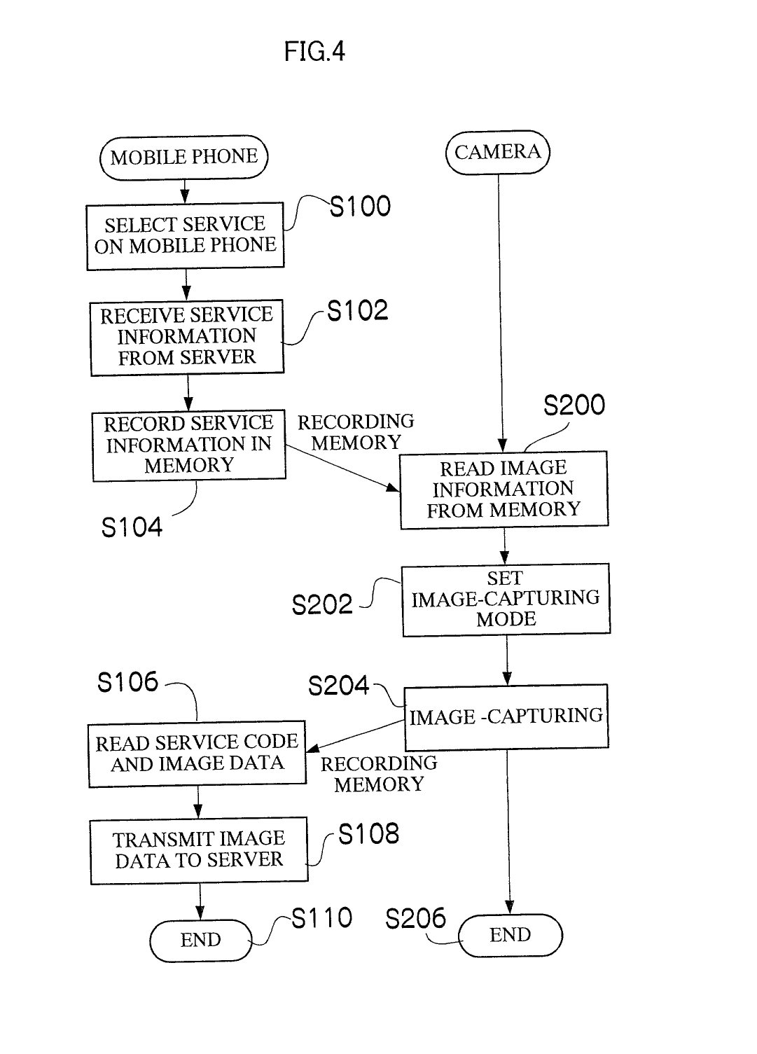

FIG. 4 shows the steps in which service information recorded in the recording medium 177 by the mobile phone 40 is read by the electronic camera 10, and the electronic camera 10 records in the recording medium 177 an image captured according to the service information.

A user firstly operates the input device 474 of the mobile phone 40 to start communication with the server 90. When communication is made with the server 90, menu information indicating kinds of display service is transmitted to the mobile phone 40 from the server 90, and the processing program performed by the information processing device 480 of the mobile phone 40 proceeds to step S100 “select service on mobile phone” of FIG. 4 (hereinafter, description will be abbreviated as S100).

Subsequently, the display device 468 of the mobile phone 40 displays the menu information received by the mobile phone 40. The user enters an area of desired service to select desired service while referring to the displayed menu information. Besides, together with the menu information, service information required for service may be downloaded at the same time.

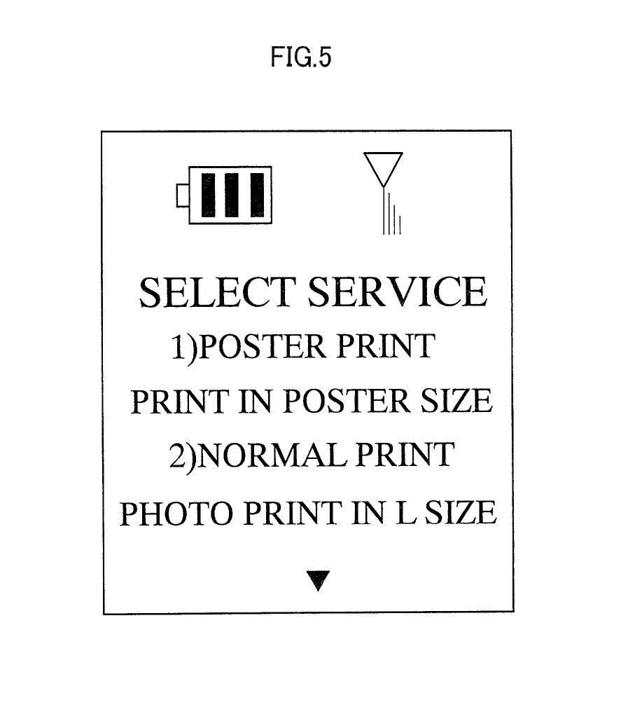

FIG. 5 shows a service selection screen which is displayed on the display device of the mobile phone 40 when the user selects service. As shown in FIG. 5, the user can select desired service such as “poster print” and “normal print” from displayed service information. Here, when the user operates a lower button provided on the input device 468, service information not displayed on the display device 468 is paged down and is displayed.

When the user inputs selection of desired service according to the menu information on the mobile phone 40, the mobile phone 40 transmits information about the selected service to the server 90. And then, the server 90 transmits service information corresponding to the service to the mobile phone 40. Subsequently, service information required for the service is transmitted to the mobile phone 40 from the server 90, and service information is downloaded in S102 “receive service information from server”.

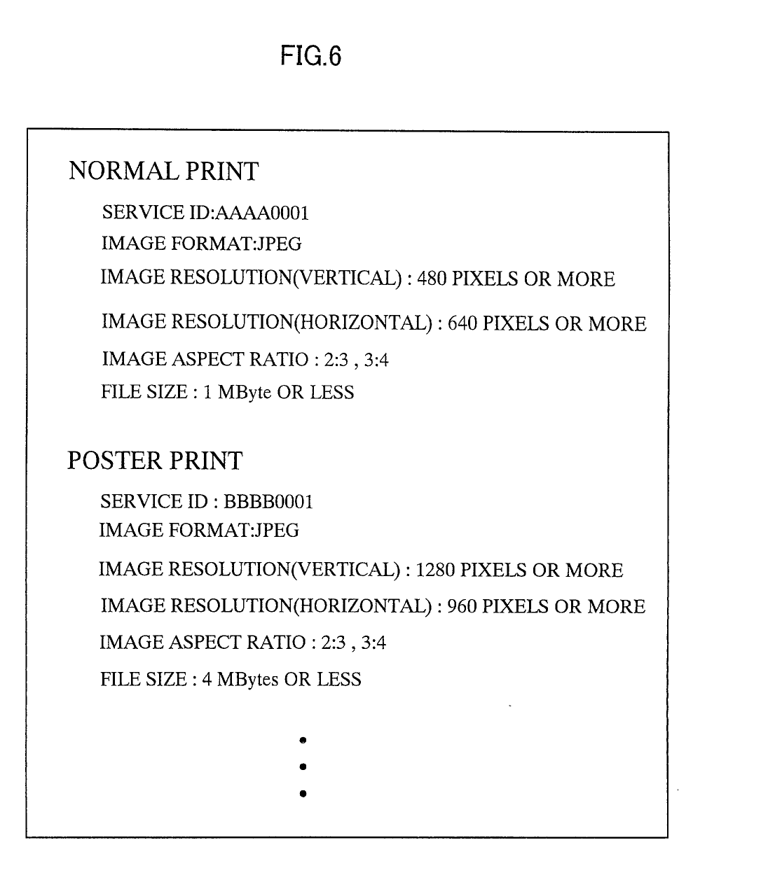

FIG. 6 shows an example of the content of service information downloaded from the server 90.

As shown in FIG. 6, the service information indicates names of service such as “normal print” and “poster print”, service IDs (including information of service content) corresponding to names of service, an image recording format (image format) such as “JPEG”, vertical and horizontal resolutions of an image that correspond to the service or a permissible range of resolution, an aspect ratio of one to a plurality of images corresponding to the service, a permissible file size of an image or a range thereof. Besides, server identifying information may be indicated for identifying specific servers being capable of providing various kinds of service.

A service ID included in the received service information and image information (including an image format, resolution of an image, a file size of an image) suitable for the service are recorded in the recording medium 177, which can be loaded and unloaded, in S104 “record service information in memory”. Additionally, although not shown in FIG. 6, model information and identifying information of a mobile phone that indicates the kind of receiving mobile phone may be stored simultaneously. This is because some kinds of service may be unavailable for a different mobile phone due to its communication protocol and processing program.

When the electronic camera 10 captures an image based on the service information and records the image in the recording medium 177, and the recording medium having the image stored therein is loaded into a mobile phone not being capable of using the service to transmit the image to the server 90, error information may be sent to the user to notify that the service is unavailable for the mobile phone.

The user unloads the recording medium 177 having service information stored therein from the recording medium loading section 478 of the mobile phone 40 and loads the recording medium 177 into the recording medium loading section 178 of the electronic camera 10. When an operation mode of the electronic camera 10 is set at an image-capturing mode and when the recording medium 177 is loaded to the recording medium loading section 178, the information processing device 180 searches if the recording medium 177 records service information or not. When the recording medium 177 records service information, the processing program of the electronic camera 10 reads service information from the recording medium 177 in S200 “read image information from memory”.

In the subsequent S202 “set image-capturing mode”, the image-capturing mode of the electronic camera 10 is set automatically such that an image indicated in the service information can be obtained. The mode automatically set at this moment is a mode such as an image format, resolution of an image, and a file size of an image.

When the image-capturing mode of the electronic camera 10 is set at an image-capturing mode suitable for service provided by the server 90, the electronic camera 10 becomes capable of capturing an image. In the subsequent S204 “image-capturing”, when the user captures an image of a subject, the electronic camera 10 records the image that is captured in a predetermined image format, in the recording medium 177. In general, when information is recorded in the recording medium 177, a transfer speed of information is much higher than that of information transfer using general-purpose communication. Thus, an image can be recorded in the recording medium 177 in a short time.

Next, the user unloads the recording medium 177 from the recording medium loading section 178 of the electronic camera 10 and loads the recording medium 177 to the recording medium loading section 478 of the mobile phone 40. Subsequently, the information processing device 480 of the mobile phone 40 reads service information recorded in the recording medium 177 in S106 “read service code and image data”. The information processing device 480 of the mobile phone 40 reads service information recorded in the loaded recording medium 177, starts communication with the server 90, which automatically performs service, and transmits predetermined image data to the server 90.

At this moment, the following operations are also applicable: service content information and server identifying information that are recorded in the recording medium 177 together with service information are read, a predetermined server is specified according to the service content and server identifying information to perform communication, and image data is transmitted.

The following will discuss another embodiment.

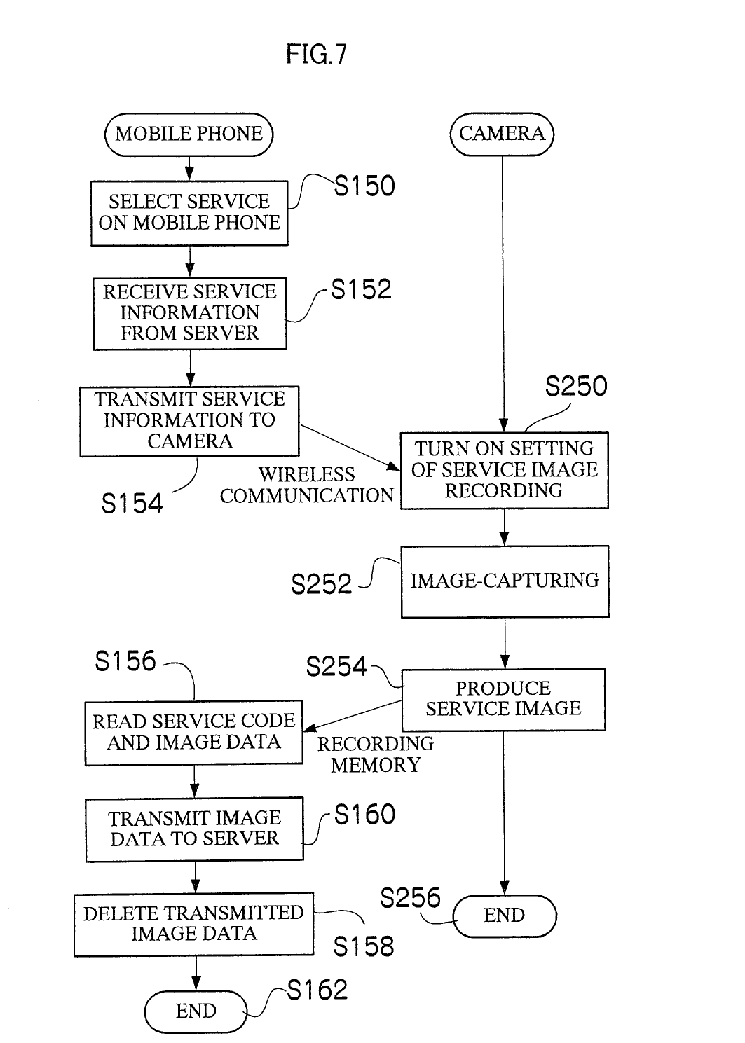

FIG. 7 shows the steps in which the electronic camera 10 receives service information received from the server 90 by the mobile phone 40, and the recording medium records an image captured by the electronic camera 10 according to the received service information.

The user firstly operates the input device 474 of the mobile phone 40 to start communication with the server 90. Subsequently, in S150 “select service on mobile phone” and S152 “receive service information from server”, in the same manner as S100 and S102, menu information indicating kinds of service is received from the server 90. And then, the display device 468 displays the received menu information. The user enters an area of desired service to select desired service while referring to the displayed menu information.

A service ID corresponding to the selected service and image information (including image format, resolution of an image, and a file size of an image) suitable for the service are transmitted to the electronic camera 10 via a communication device such as wireless communication in S154 “transmit service information to camera”.

When the service information is received from the mobile phone 40, the processing program of the electronic camera 10 automatically sets an image-capturing mode of the electronic camera 10 in S250 “turn on image setting for service” so as to obtain an image corresponding to the content of the service information. A mode set automatically at this moment is a mode such as an image format, resolution of an image, and a file size of an image. Besides, during image-capturing, when an image-capturing mode (including an image-capturing condition and a recording condition) set directly by the user in advance is different from an image-capturing condition included in the above service information, an image may be captured in two different image-capturing modes to record images in two different recording formats in the recording medium 177.

When the image-capturing mode of the electronic camera 10 is also set for an image-capturing mode suitable for service provided by the server 90, the electronic camera 10 is capable of capturing an image. In the subsequent S252 “image-capturing”, when the user captures an image of a subject, the electronic camera 10 records the image that is captured in a predetermined image format in one or more recording formats, and service information, which is received by the mobile phone 40, in the recording medium 177.

Next, the user unloads the recording medium 177 from the recording medium loading section 178 of the electronic camera 10 and loads it into the recording medium loading section 478 of the mobile phone 40. Subsequently, the information processing device 480 of the mobile phone 40 reads service information recorded in the recording medium 177 in S156 “read service code and image data”. The information processing device 480 of the mobile phone 40 reads service information recorded in the loaded recording medium 177, starts communication with the server 90, which automatically performs service, and transmits image data undergoing predetermined service to the server 90.

At this moment, the following operations are also applicable: service content information and server identifying information are read, which are recorded in the recording medium 177 together with service information, a predetermined server is specified according to the service content and server identifying information to perform communication, and image data is transmitted.

Additionally, when image data undergoing service is transmitted to the server 90, service information recorded in the recording medium 177 and an image undergoing service are unnecessary. Thus, the service information and the image may be deleted automatically or manually.

Besides, service information of an image undergoing service may include any one of an image format, an image resolution, an aspect ratio of an image, and a file size. Further, service information recorded in the recording medium 177 may be an independent file. When service information is recorded with a captured image, the service information may be stored in a header and the like in an image file.

Moreover, when specification is made within a permissible range regarding an aspect ratio, the number of pixels, compressibility, or a file size that is included in service information inputted by the service information input device, the information processing device 180 may automatically select a maximum value or a minimum value within the permissible range, and the recording medium interface 179 (or a recording device such as the information processing device 180) may record an image based on the selected service information in the recording medium 177.

Moreover, in the case where the user specifies recording conditions of an image that include a predetermined aspect ratio, the number of pixels, compressibility, and a file size via the input device 174, when the recording conditions specified by the user are within a permissible range of service information that is inputted from the electronic camera 10 and includes an aspect ratio, the number of pixels, compressibility and a file size, the recording medium may record an image based on the recording conditions specified by the user.

Also, when the service information including an aspect ratio, the number of pixels, compressibility, and a file size is specified within a permissible range, the user may specify service information including a desired aspect ratio, the number of pixels, compressibility, and a file size within the range via the input device 174 (specifying device). In this case, the recording device such as the recording medium interface 179 and the information processing device 180 records an image based on service information specified by the user in the recording medium 177.

Moreover, in the above two embodiments, an image-capturing mode and condition are changed to capture an image, and the captured image is recorded in the recording medium and is transmitted to the server 90 via the mobile phone 40. The present invention is not limited to the above examples. The following example also attains the object of the present invention: the user selects an image undergoing service from images recorded in the recording medium 177 in advance, an image format, an image resolution, an image aspect ratio, and so on are automatically changed or converted if necessary, and the image is recorded again in the recording medium 177. In this case, a newly recorded image file may be recorded as an additional image file of a pre-converted image or may be written over a pre-converted image file.

Besides, an image undergoing service may be transmitted to the server 90 automatically as described above, or permission for uploading may be requested to the user. Also, when an image is deleted after transmission as well, permission for deletion may be requested to the user.

As described above, the portable device of the present invention includes a service information input device which inputs service information of image service from a communication device such as a mobile phone, and a recording device which store an image based on the inputted service information in a recording medium. Thus, when an image is transferred to the mobile phone via the recording medium, which can be loaded and unloaded, it is possible to readily record in the recording medium with ease an image which is automatically changed in size or compressibility according to obtained service information at high speed.

Further, the mobile phone of the present invention includes a receiving device which receives service information of image service, a service information output device which outputs the received service information to the portable device, and a transmitting device which transmits an image read from the recording medium to a server. The recording medium can be loaded and unloaded. Thus, it is possible to readily transmit an image meeting the request of the server at high speed.

Moreover, the image transmission system of the present invention is composed of the mobile phone including the receiving device which receives service information of image service from the server, the service information output device which outputs the received service information to the portable device, and the transmitting device which transmits an image read from the recording medium to a server, the recording medium being loaded and unloaded, and the portable device including the service information input device which inputs service information of image service from a mobile phone, and the recording device which records an image based on the inputted service information in a recording medium, which can be loaded and unloaded. Hence, when an image is transferred to the mobile phone via the recording medium, which can be loaded and unloaded, it is possible to automatically change the size or compressibility of an image based on obtained service information before the image is recorded in the recording medium and to readily transmit the image to the server via the mobile phone at high speed.

Additionally, according to the image transmission system and the method of transmitting an image of the present invention, it is possible to transmit necessary and sufficient image data to the server according to the service content of an image requested by the user.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A portable device which records, in a recording medium, an image to be transmitted to a server via a communication device such as a mobile phone, the server providing image service such as printing and distribution service of an image, the portable device comprising:
a service information input device which inputs, from the communication device, service information about image service such as:
a format of the image such as an image recording format or an image format;
an aspect ratio of the image or a permissible range of the aspect ratio;
numbers of pixels in vertical and horizontal directions of the image or a permissible range of the numbers of pixels; and
compressibility for compressing and recording the image, a file size of the image upon recording, or a permissible range of the compressibility or the file size; and
a recording device which records the image based on the inputted service information in the recording medium.

2. The portable device according to claim 1, wherein the recording device records the service information together with the image in the recording medium.

3. The portable device according to claim 1, wherein:
the input device inputs server identifying information for specifying the server together with the service information; and
the recording device records the server identifying information together with the image.

4. The portable device according to claim 1, wherein:
the input device inputs service content information indicating the content of the image service; and
the recording device records the service content information together with the image.

5. The portable device according to claim 1, further comprising:
an image-capturing device which captures an image,
wherein the recording device converts the captured image to an image based on the service information and records the image in the recording medium.

6. The portable device according to claim 1, further comprising:
an image reading device which reads an image from an image recording device for recording an image,
wherein the recording device converts an image read from the image recording device to an image based on the service information, and records the image in the recording medium.

7. The portable device according to claim 1, wherein the service information input device reads service information recorded in the recording medium and inputs service information.

8. The portable device according to claim 1, wherein the service information input device inputs service information via a wire or wireless communication device.

9. The portable device according to claim 1, wherein when specification is made within a permissible range regarding an aspect ratio, the number of pixels, compressibility, or a file size that is included in the service information, the recording device automatically selects a maximum value or a minimum value within the permissible range, and records an image based on the selected service information in the recording medium.

10. The portable device according to claim 1, further comprising:
a specifying device which allows a user to specify service information including a predetermined aspect ratio, the number of pixels, compressibility, or a file size within a permissible range when specification is made within the permissible range regarding service information including a predetermined aspect ratio, the number of pixels, compressibility, or a file size,
wherein the recording device records an image in the recording medium according to service information specified by the user.

11. The portable device according to claim 1, further comprising:
an input device which allows a user to specify conditions of recording an image, the conditions including an aspect ratio of a predetermined image, the numbers of pixels in vertical and horizontal directions of an image, compressibility for compressing and recording an image, or a file size of an image upon recording,
wherein when recording conditions specified by the user are within a permissible range of the corresponding service information inputted from a communication device such as the mobile phone, an image based on the recording conditions specified by the user is recorded in the recording medium.

12. A mobile phone which is capable of performing voice communication, communicating information to a server for providing image service such as printing service and distribution service of an image, and transmitting an image recorded in a recording medium to the server, the recording medium being loaded and unloaded, the mobile phone comprising:
a receiving device which receives, from a server, service information about image service such as:
a format of the image such as an image recording format or an image format;
an aspect ratio of the image or a permissible range of the aspect ratio;
numbers of pixels in vertical and horizontal directions of the image or a permissible range of the numbers of pixels; and
compressibility for compressing and recording the image, a file size of the image upon recording, or a permissible range of the compressibility or the file size;
a service information output device which outputs the received service information to a portable device; and
a transmitting device which transmits to the server the image read from the recording medium.

13. The mobile phone according to claim 12, wherein:
the recording medium records server identifying information for specifying the server, together with the image; and
the transmitting device transmits the image to a server specified according to server identifying information recorded in the recording medium.

14. The mobile phone according to claim 12, wherein:
the recording medium records service content information indicating service content of the image, together with the image; and
the transmitting device transmits service content information recorded in the recording medium to the server together with the image.

15. The mobile phone according to claim 12, wherein the service information output device records the received service information in the recording medium and outputs the service information to the portable device via the recording medium.

16. The mobile phone according to claim 12, wherein the service information output device outputs the received service information to the portable device via a wireless or wire communication device.

17. An image transmission system which transmits an image to a server for providing image service such as printing and distribution of the image, the image transmission system comprising:
a mobile phone comprising:
a receiving device which receives, from the server, service information about image service such as:
a format of the image format such as an image recording format or an image format;
an aspect ratio of the image or a permissible range of the aspect ratio;
numbers of pixels in vertical and horizontal directions of the image or a permissible range of the numbers of pixels; and
compressibility for compressing and recording the image, a file size of the image upon recording, or a permissible range of the compressibility or the file size;
a service information output device which outputs the received service information to a portable device; and
a transmitting device which transmits to the server the image read from a recording medium being loaded and unloaded; and
a portable device comprising:
a service information input device which inputs service information about the image service from the mobile phone; and
a recording device which records an image based on the inputted service information in the recording medium.

18. A method of transmitting an image to a server for providing image service such as printing and distribution of an image, the method comprising the steps of:
allowing a mobile phone to receive, from the server, service information about image service such as:
a format of an image such as an image recording format or an image format;
an aspect ratio of the image or a permissible range of the aspect ratio;
numbers of pixels in vertical and horizontal directions of the image or a permissible range of the numbers of pixels; and
compressibility for compressing and recording the image, a file size of the image upon recording, or a permissible range of the compressibility or the file size;
allowing the mobile phone to output the received service information to a portable device;
allowing the portable device to input the outputted service information from the mobile phone;
allowing the portable device to record an image based on the inputted service information in a recording medium being loaded and unloaded, and
allowing the mobile phone to transmit to the server the image read from the recording medium.
